(19) United States
(12) Patent Application Publication
(10) Pub. No.: US 2004/0140729 A1
(43) Pub. Date: Jul. 22, 2004

(54) Armature of rotary electric machine and starter having the armature

(75) Inventor: Masami Niimi, Handa-city (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/754,688

(22) Filed: Jan. 12, 2004

(30) Foreign Application Priority Data
Jan. 20, 2003 (JP) 2003-011317

(51) Int. Cl. H02K 1/00

(52) U.S. Cl. 310/233; 29/597

(57) ABSTRACT

In an armature for a rotary electric machine, segments of a commutator are provided by coil ends arranged on one axial end of the armature. A brush of the rotary electric machine is arranged to contact the commutator segments in an axial direction of the armature. On the surfaces of the commutator segments, a plurality of grooves is formed in circular rows concentric with an armature shaft, at approximately equal intervals in a radial direction. The contact area of the commutator and the brush is increased because of the grooves, in comparison to that of an armature having flat commutator surfaces. Therefore, because current density on the contact surface during the energization is approximately between 50% to 60%, voltage drop loss is reduced accordingly. As a result, power output is improved.

### CROSS-REFERENCE TO RELATED APPLICATION

This application is based on Japanese Patent Application No. 2003-11317 filed on Jan. 20, 2003, the disclosure of which is incorporated herein by reference.

### FIELD OF THE INVENTION

The present invention relates to an armature including a commutator for a rotary electric machine and a starter having the armature.

### BACKGROUND OF THE INVENTION

In recent years, deterioration of global environment, such as global warming caused by the increasing atmospheric carbon dioxide, is a problem. To protect the global environment, vehicles have faced the task of improving fuel economy and vehicle engines have been improved. Regarding a vehicle starter provided as an ancillary equipment for the engine, it is required to reduce size and weight of a starter motor, which is relatively heavy in the starter.

To meet this demand, JP-B2-2924605 (U.S. Pat. No. 5,508,577, U.S. Pat. No. 5,650,683, U.S. Pat. No. 5,864,193) discloses a rotary electric machine which does not need to provide a commutator separately. Specifically, commutator surfaces are provided by the part of armature coil. Further, in the rotary electric machine, undercutting process, which is generally required to a conventional commutator, is not required. Therefore, manufacturing costs and the number of manufacturing process are decreased.

### SUMMARY OF THE INVENTION

The present invention is made in view of the above matters, and it is an object of the present invention to provide a compact, lightweight armature for a rotary electric machine, which is capable of improving performance.

According to the present invention, an armature for a rotary electric machine has a commutator. The commutator defines a brush-slide surface over which a brush of the rotary electric machine contacts and slides. The commutator includes a means for increasing a contact area with the brush on the brush-slide surface.

Accordingly, since a predetermined contact area is provided by the contact area increasing means, a contact voltage drop, which is caused by a decrease of the contact area, is restricted. Therefore, it is possible to improve performance of the compact, lightweight armature. Preferably, the contact area increasing means is provided by a plurality of grooves formed on the brush-slide surface.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic cross-sectional view of an armature according to a first embodiment of the present invention;

FIG. 2 is an end view of the armature, viewed along a rotation axis, according to the first embodiment of the present invention;

FIG. 3 is an enlarged cross-sectional view of a commutator segment of the armature according to the first embodiment of the present invention; and

FIG. 4 is a side view of an armature, including partly cross-section, according to a second embodiment of the present invention.

### DETAILED DESCRIPTION OF EMBODIMENTS

Embodiments of the present invention will be described hereinafter with reference to the drawings.

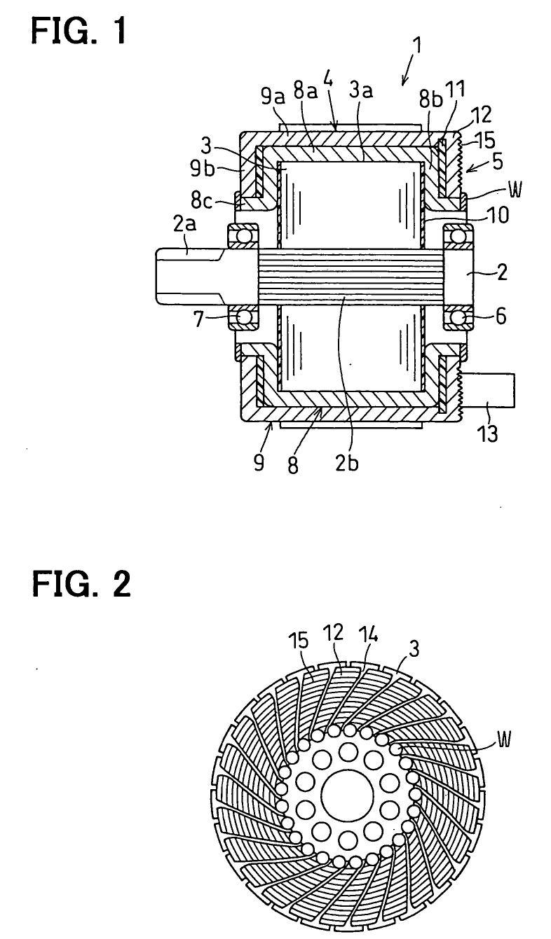

Referring to FIG. 1, in the first embodiment, an armature 1 of the present invention is for example used for a motor of a vehicle starter. The motor is a d. c. motor and the armature 1 functions as a rotor. The armature 1 includes an armature shaft 2, an armature core 3 supported by the armature shaft 2, an armature coil 4 wrapped around the armature core 3, and a commutator 5.

The armature shaft 2 is rotatably supported by a first bearing 6 and a second bearing 7. The first bearing 6 is held on an end frame (not shown) that closes a rear end of a motor. The second bearing 7 is held on a partition wall (not shown) that is integrally formed with a motor yoke (not shown). The end of the armature shaft 2 (left end in FIG. 1) is provided with a sun gear 2a. For example, the sun gear 2a meshes with a planetary gear of a planetary reduction gear device (not shown) so that rotation of the armature shaft 2 is transmitted to the planetary gear.

The armature core 3 is constructed of a stack of thin steel plates in the form of disc. The armature core 3 is fitted on the armature shaft 2. Further, the armature core 3 is engaged with serrations 2b formed on a circumferential surface of the armature shaft 2.

On the periphery of the armature core 3, the predetermined number of slots 3a is formed. The slots 3a are arranged at equal intervals in a circumferential direction of the armature core 3. Further, each of the slots 3a extends from a first axial end to a second axial end of the armature core 3.

The armature coil 4 is constructed of inside conductive members 8 and outside conductive members 9. Each of the inside conductive members 8 has an inside coil trunk 8a and a pair of inside coil ends 8b extending from the axial ends of the inside coil trunk 8a. The inside conductive member 8 is arranged on the armature core 3 such that the inside coil trunk 8a is located in the slot 3a and the inside coil ends 8b are located substantially parallel to the axial end surfaces of the armature core 3. Further, the inside coil ends 8b are formed with projections 8c projecting axially outside of the armature core 3, at the ends.

Each of the outside conductive members 9 has an outside coil trunk 9a and a pair of outside coil ends 9b extending from the axial ends of the outside coil trunk 9a. The outside conductive member 9 is arranged such that the outside coil trunk 9a is located radially outside of the inside coil trunk 8a in the inside of the slot 3a and the outside coil ends 9b are located axially outside of the inside coil ends 8b.

After mounting on the armature core 3, the inside conductive members 8 and the outside conductive members 9 are electrically and mechanically connected at the projection 8c of the inside coil ends 8b and the ends of the outside coil ends 9b such as by welding (welding portions W in FIG. 1). Thus, the armature coil 4 is formed.

Slot insulating paper (not shown) is interposed between the wall of the slot 3a and the inside coil trunk 8a and between the inside coil trunk 8a and the outside coil trunk 9a. Further, resinous insulating plates 10, 11 are interposed between the axial end surface of the armature core 3 and the inside coil ends 8b and between the inside coil ends 8b and the outside coil ends 9b, respectively.

In the first embodiment, the commutator 5 is a face-type commutator. The brush 13 is arranged to face and contact the axial end surfaces of the outside coil ends 9b that are arranged on one axial end of the armature core 3 (right end in FIG. 1) in the axial direction. Namely, the outside coil ends 9b on one axial end are used as commutator segments. The axial end surfaces of the outside coil ends 9b provide commutator surfaces. Hereafter, the outside coil ends 9b with which the brush 13 contacts are referred to as commutator segments 12.

The brush 13 is held in a brush holder (not shown) that is fixed on the end frame. The brush 13 is biased to the commutator surfaces of the segments 12 by a spring (not shown) that is provided on an end of the brush 13 on a side opposite to the commutator 5.

As shown in FIG. 2, the segments 12 are regularly arranged with gaps 14 between them in the circumferential direction. The gaps 14 correspond to the undercutting, which is formed in a conventional commutator. Therefore, the segments 12 are insulated from each other. Further, the segments 12 are insulated from the inside coil ends 8b by the insulating plate 11.

On the commutator surfaces of the segments 12, a plurality of grooves 15 are formed in a circular row fashion. The grooves 15 are substantially concentric with the armature shaft 2 and are spaced from each other at substantially equal intervals in a radial direction of the armature 1. The grooves 15 provide a means for increasing a contact area of the commutator 5 with the brush 13.

In the embodiment, the plurality of grooves 15 are formed entirely on the commutator surfaces, as shown in FIG. 2. The grooves 15 can be formed at least on portions or areas on which the brush contacts and slides during the rotation. The portions of the commutator surfaces on which the brush contacts and slides are referred to as brush-slide surfaces of the present invention.

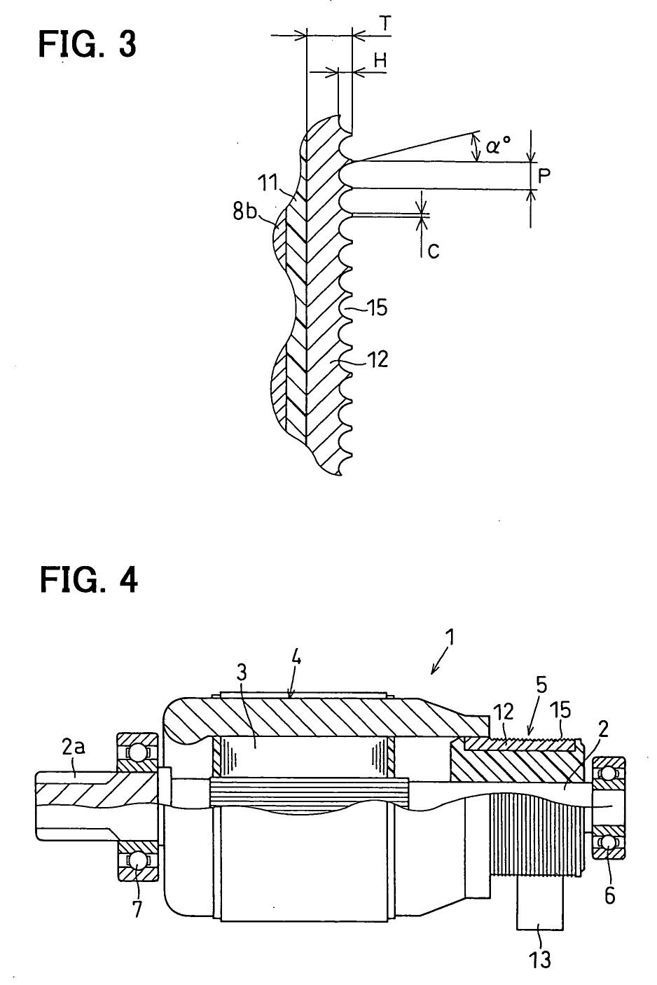

The grooves 15 is formed such that a width of each groove 15 gradually reduces from the commutator surface toward the bottom. That is, the width of the groove 15 is gradually decreased with its depth. Specifically, as shown in FIG. 3, at least one of the side walls defining the groove 15 is inclined at an angle α° with respect to a longitudinal direction of the armature shaft 2. A dimension (width) C of each apex that is between the adjacent grooves 15 and included in the commutator surface is less than one-half of the pitch P between the grooves 15. (C<½P)

To restrict strength deterioration of the segments 15 due to grooves 15, a depth H of the groove 15, that is, a dimension from the commutator surface to the bottom of the groove 15 is less than one-half of a thickness T of the segment 12. (H<½T) Therefore, the commutator 15 provides strength against centrifugal force. Here, the commutator 12 is formed of a material having a hardness higher than that of a material forming the brush 13.

FIG. 4 shows the armature 1 of the second embodiment. In the second embodiment, the armature 1 has a cylindrical-type commutator 5. The cylindrical-type commutator 5 is constructed of the segments 12 that are arranged in a cylindrical fashion around the armature shaft 2. The segments 12 connect to the armature coil 4. The brush 13 is arranged to face and contact the peripheral surfaces of the segments 12. The peripheral surfaces of the segments 12 provide the commutator surfaces.

Similar to the first embodiment, the plurality of grooves 15 are formed on the commutator surfaces of the segments 12. The grooves 15 are formed in a circumferential direction of the cylindrical commutator 5 and are spaced from each other at approximately equal intervals in the axial direction. At least one of the side walls defining the groove 15 is inclined with respect to the direction perpendicular to the armature shaft 2 at the angle α°. Thus, the width of each groove 15 is gradually decreased from the commutator surfaces toward the bottom. The relation between the depth H of the groove 15 and the thickness T of the segment 12 and the relation between the width C of each apex and the pitch P of the grooves 15 are similar to those of the first embodiment.

Next, advantageous effect of the first and the second embodiments will be described.

When the brush 13 contacts and slides over the commutator surfaces during rotation of the armature 1, the contact portions of the brush 13 opposing to the apexes between the grooves 15 abrades or wears. Accordingly, grooves or wave shapes are formed on the end surface of the brush 13, and therefore, the end of the brush 13 can enter inside of the grooves 15 and makes contact with the side walls of the grooves 15.

The contact area of the commutator surfaces and the brush 13 and performance of the embodiments are compared to those of the commutator having flat commutator surfaces. First, the contact area between the commutator 5 and the brush 13 of the embodiments is between one and a half times and twice of that of the flat commutator surface. Since the contact area is increased in the embodiments, current density on the contact surface while the electric power is supplied is approximately between 50% to 60%. Therefore, because voltage drop loss is reduced accordingly, the power output is increased. For example, if the embodiment is employed to the 1.6 KW class starter, maximum power output is increased approximately 9.0%.

In general, the size reduction of the commutator 5 and the brush 13 results in an increase in current density on the contact surface during the energization. To solve this, it is required to increase a biasing force of the brush 13. However, the increase in the biasing force results in an increase in torque loss. In this case, therefore, it is required to increase an amount of the material such as iron, for example, to increase the core length. Thus, it is still difficult to reduce size and weight of the motor. Regarding the vehicle starter, in fact, to address size and weight reduction, a speed reducing ratio is increased so that the torque of the motor is reduced and the rotation speed is high. Therefore, the degree of the torque loss of the motor itself is likely to increase.

On the other hand, in the embodiments, it is not required to increase the biasing force of the brush 13. Therefore, this does not cause an increase in the torque loss. Accordingly, it is possible to further reduce size and weight of the starter.

Further, the brush 13 enters in the insides of the grooves 15. Therefore, the brush 13 slides over the commutator surfaces stably. Accordingly, it is less likely to generate sparks. Further, this increases life of the brush 13. This is advantageous to the vehicle starter because the rotation speed of the motor in a loaded condition is likely to increase higher than an idling speed of the motor.

Since the sliding stability of the brush 13 is improved, loss of the voltage drop between the commutator 15 and the brush 13 during the idling is reduced. Therefore, the idling speed of the motor is increased. In the embodiments, the idling speed is increased 20% from that of the conventional commutator having flat commutator surfaces.

This is effective for a magnetic field-type motor that generates magnetic field by permanent magnets. In the vehicle starter, it is necessary to follow the rotation speed of the starter to the engine rotation speed immediately after starting the engine. In the magnetic-field-type motor, because the idling speed is low, an auxiliary magnetic pole is provided to increase the idling speed. In the embodiments, however, the idling speed is improved without using the auxiliary magnetic pole. Therefore, if the motor of the embodiments is employed to the magnetic-field type motor, the idling speed can be increased without using the auxiliary magnetic poles. This results in cost reduction.

Since the material of the commutator 5 is harder than the brush 13, the contact area increases as the contact surface of the brush 13 wears on the commutator surfaces. Therefore, it is not necessary to previously shape the contact surface of the brush 13 to correspond to the shape of the commutator surfaces.

In an early stage of the slide-contact of the brush 13 onto the commutator surfaces, the biasing force of the brush 13 is applied onto the apexes between the grooves 15. If the width C of the apex is less than one-half of the pitch P, surface pressure or stress on the apex is higher than the other portions. Accordingly, the brush 13 wears on the apexes of the commutator 5 first. Therefore, the brush 13 is conformed to the shape of the commutator surfaces at early stage. This provides an enhanced slide-contacting of the brush 13 to the commutator surfaces.

At least one of the side walls defining the groove 15 is inclined so that the width of each groove 15 is gradually reduced from the top to the bottom. The inclined wall can be curved. Since the biasing force of the brush 13 can be received by the side walls of the grooves 15, the contact area is increased.

In general, the flat commutator surfaces are processed by a general cutting tool. In the embodiments, on the other hand, the grooves 15 are for example made such as by cutting or plastic working by pressing. Because the commutator surfaces are processed by using a form cutting device or a pressing die, the plurality of grooves 15 are formed at the same time. Accordingly, the processing costs are decreased.

The present invention should not be limited to the disclosed embodiment, but may be implemented in other ways without departing from the spirit of the invention.

What is claimed is:

1. An armature for a rotary electric machine having a brush, the armature comprising:
a commutator defining a brush-slide surface over which the brush contacts and slides, wherein the commutator includes a means for increasing a contact area with the brush.

2. The armature according to claim 1, wherein
the commutator is a face-type commutator in which the brush-slide surface is disposed perpendicular to a rotation axis,
the means is provided by grooves on the brush-slide surface, and
the grooves are arranged in circular rows substantially concentric with the rotation axis.

3. The armature according to claim 2, wherein the grooves are formed such that a width of each groove gradually reduces from the brush-slide surface to a bottom of the groove.

4. The armature according to claim 3, wherein each of the grooves is formed such that at least one of side walls defining the groove is a flat surface and is inclined with respect to a longitudinal direction of the rotation axis.

5. The armature according to claim 3, wherein each of the grooves is formed such that at least one of side walls defining the groove is curved.

6. The armature according to claim 2, wherein the grooves are formed such that each apex defined between the grooves has a dimension with respect to a radial direction less than one-half of a pitch between the grooves, the apex being contained in the brush-slide surface.

7. The armature according to claim 2, wherein the commutator is constructed of a plurality of segments each defining the brush-slide surface, and each of the grooves is formed such that a depth of the groove is less than one-half of a thickness of the segment.

8. The armature according to claim 2, wherein the grooves are formed by one of cutting and plastic working by pressing.

9. The armature according to claim 2, wherein the commutator is made of a material having a hardness higher than that of a material making the brush.

10. The armature according to claim 2, further comprising:
an armature shaft;
an armature core rotatably supported by the armature shaft; and
an armature coil wound around the armature core, wherein the brush-slide surface is contained in an axial end surface of the armature coil.

11. The armature according to claim 1, wherein
the commutator is a cylindrical-type commutator in which the brush-slide surface is disposed on a circumference of a cylinder having an axis coincident with a rotation axis,
the means is provided by grooves on the brush-slide surface, and
the grooves are formed in a circumferential direction and spaced from each other in an axial direction.

12. The armature according to claim 11, wherein the grooves are formed such that a width of each groove gradually reduces from the brush-slide surface.

13. The armature according to claim 12, wherein each of the grooves is formed such that at least one of side walls defining the groove is a flat surface and is inclined.

14. The armature according to claim 12, wherein each of the grooves is formed such that at least one of side walls defining the grooves is curved.

15. The armature according to claim 11, wherein the grooves are formed such that each apex defined between the grooves has a dimension with respect to the axial direction less than one-half of a pitch between the grooves, the apex being contained in the brush-contact surface.

16. The armature according to claim 11, wherein the commutator is constructed of a plurality of segments each defining the brush-slide surface, and each of the grooves is formed such that a depth of the groove is less than one-half of a thickness of the segment.

17. The armature according to claim 11, wherein the grooves are formed by one of cutting and plastic working by pressing.

18. The armature according to claim 11, wherein the commutator is made of a material having a hardness higher than that of a material making the brush.

19. The armature according to claim 16, further comprising:
an armature shaft;
an armature core rotatably supported on the armature shaft; and
an armature coil provided on the armature core, wherein the segments connect to the armature coil.

20. A vehicle starter comprising the armature according to claim 1.
